(19) United States
(12) Patent Application Publication
(10) Pub. No.: US 2026/0090504 A1
(43) Pub. Date: Apr. 2, 2026

(54) COMBINE CONCAVE WITH ADJUSTABLE GRATING PLATE

(71) Applicant: COPPERHEAD AGRICULTURAL PRODUCTS, LLC., Humboldt, SD (US)

(72) Inventor: Marlin UNRUH, Madrid, NE (US)

(21) Appl. No.: 19/078,034

(22) Filed: Mar. 12, 2025

Related U.S. Application Data
(60) Provisional application No. 63/701,972, filed on Oct. 1, 2024.

(51) Int. Cl. A01F 12/28; A01F 12/26

(52) U.S. Cl. CPC A01F 12/28; A01F 12/26

(57) ABSTRACT

A combine concave is provided, including a frame including a plurality of spaced, vertical frame members each having an upper end and an opposite lower end, a mount plate connecting the upper ends, and a mount clevis connecting the lower ends, a plurality of disruptor bars mounted to the frame in spaced, parallel orientation, a grating plate slidably positioned against a rear surface of each of the disruptor bars, the grating plate defining a plurality of spaced, parallel slots, the grating plate being movable relative to the disruptor bars between a first position, where the plate blocks spaces between the disruptor bars, and a second position, where the plate allows free passage of material through the disruptor bars.

### RELATED APPLICATION

This application is a Non-Provisional of, and claims 35 U.S.C. 119 priority from, U.S. Provisional Patent Application Ser. No. 63/701,972 filed Oct. 1, 2024, the entire contents of which are incorporated by reference herein.

### BACKGROUND

The present invention relates generally to the agricultural combine harvesters, and more specifically to an improved concave for a combine harvester, also known as a combine.

A combine is so named because it is an agricultural machine that combines three separate harvesting machines and processes into one: cutting the crop (reaping), comminuting the grains of the crop (threshing), and separating the grains of the crop (collecting). Combines are usually self-propelled vehicles that are driven into and through crops ready for harvesting. The operation and working components of a typical combine are well known in the art.

Conventional combines include an internal threshing assembly, used to comminute the grain from the stalk of the crop plant. This is accomplished using a rotating drum having radially-projecting extensions configured for rotating in a cylindrical space defined by a plurality of concaves, which are arcuate frames spanned by spaced, parallel disruptor bars. As the crop plants are fed into the thresher assembly, the action of the rotating rotor against the crop plants causes comminution of the plants, and separation of the seeds from the stalks, resulting in the grains falling through openings in the concave between the disruptor bars.

Most conventional concaves are equipped with grates or gratings located behind the disruptor bars. Prior to harvesting, the grates are mounted to the concave by the user in a position which corresponds to the size of the plant being harvested. The purpose of the grates is for adjusting the size of particles which are allowed to pass through the concave. As such, there is a first mounting position for corn, a second for wheat, a third for barley, etc. When the user changes target crops for harvesting, the grates are moved into new positions, or different grates are installed depending on the crop being harvested.

A drawback of conventional combine cover or grate plates is that they retain more grain in the concave, leading to increased grain-on-grain threshing. This effect is more significant for small grains. The smaller the grain, the more the cover plates need to be closed to retain the optimal amount of grain for efficient threshing. Also, conventional combine cover or grate plates release grain in a localized area rather than dispersing it move evenly, which tends to create localized overloading of the downstream combine grain-processing operations. This problem reduces combine operational efficiency.

Another feature of conventional combines is that several concaves are mounted along an axial length of the rotor, with the grating position varying by the position of the concave. In general, the grates are mounted so that openings between the disruptor bars are increased (grating blocking is reduced) as the crops move toward a rear end of the combine, for allowing the passage of more plant material.

Users growing multiple species of crops must install, then remove, the appropriate plate whenever the target crop is changed. The plates are large, heavy, and cumbersome. When not in use, the plates take up significant storage space in barns or storage sheds. There is also significant time and labor loss with the installation and removal of each plate before harvesting.

Accordingly, there is a need for an improved combine concave which addresses the above-listed problems of conventional devices.

### SUMMARY

The above-listed need is met or exceeded by the present combine concave, which features a user-adjustable grating plate that remains with the concave regardless of the crop being harvested. In the present concave, the plate is slidably adjustable relative to a rear side of the disruptor bars in a number of adjustable positions determined by the user. The present grating plate defines a plurality of spaced, parallel slots. User adjustment moves the grating plate between a first position, blocking a space between the disruptor bars, to a second position, in which the space between the disruptor bars is totally open, allowing the free flow or passage of crop material past the concave. A multitude of interim grating plate positions allow for user regulation of the size of the opening through which the crop material flows. Also, an advantage of the present combine concave is a more even distribution of threshed grain. A frame of the concave is preferably provided with a plurality of vertically spaced grate retainers configured for retaining the grating plate in position against the rear side of the disruptor bars.

Another feature of the present combine concave is a clamp mechanism that provides user adjustability of the position of the grating plate relative to the disruptor bars. A grate positioner bracket is slidable vertically along a vertical frame rail of the concave, and at one end has teeth engaging complementary openings in the grating plate. Thus, the grate positioner bracket moves between the first and second positions of the grating plate relative to the disruptor bars. Once the desired grating plate position is reached, allowing a desired crop-specific opening behind the disruptor bars, the grate positioner bracket is fixed in place using threaded fasteners or the like. Another feature of the present combine concave is an adjustment gauge that the user employs to achieve consistent and repeatable grating plate positioning. In the preferred embodiment, the adjustment gauge is configured as a plurality of sawtooth projections, and a projecting portion of the grate positioner bracket overlaps the sawtooth projections for providing the user with an adjustment reference point. A further feature of the grate positioner bracket is a fitting for accepting a wrench or other tool to increase user leverage in the event the grating plate becomes stuck in the concave frame due to trapped debris or the like.

Still another feature of the present concave is that the disruptor bars are specially designed to accommodate the sliding action of the grating plate. As such, the disruptor bars have a relatively planar rear surface, and an opposite, front surface with a material retaining notch, and in a preferred embodiment, a hardface surface to resist abrasion. In a preferred embodiment, the notch defines a right angle.

More specifically, a combine concave is provided, including a frame including a plurality of spaced, vertical frame members each having an upper end and an opposite lower end, a mount plate connecting the upper ends, and a mount clevis connecting the lower ends, a plurality of disruptor bars mounted to the frame in spaced, parallel orientation, a grating plate slidably positioned against a rear surface of each of the disruptor bars, the grating plate defining a plurality of spaced, parallel slots, the grating plate being movable relative to the disruptor bars between a first position, where the plate blocks spaces between the disruptor bars, and a second position, where the plate allows free passage of material through the disruptor bars.

In an embodiment, the vertical members have a plurality of vertically spaced grate retainers constructed and arranged to slidably retain the grating plate against the disruptor bars. Preferably, each grate retainer has an arcuate surface configured for engaging the grating plate.

In an embodiment, a grate positioner bracket is slidably mountable on the frame and is configured for moving the grating plate under user control relative to the concave frame. In a preferred version, the bracket has at least one tooth for engaging a complementary opening on the grating plate, so that the grate positioner is movable with said grating plate relative to the frame.

In an embodiment, the grate positioner bracket is selectively fixable relative to the frame using threaded fasteners. Another feature of the grate positioner bracket is a rearward projecting portion operationally engaging an indicator. In a preferred embodiment, the indicator has a sawtoothed edge. Further, in an embodiment, the projecting portion has a tool access aperture.

In an embodiment, the grate positioner bracket is configured as a grating positioner system, and includes a lever with a handle and a cam bushing configured for engaging a cam recess in an actuator, the actuator having teeth engaging the grating plate, so that rotation of the lever causes the actuator to move the grating plate between the first position and the second position relative to the concave. In a preferred embodiment, a user-releasable locking mechanism is provided for securing the actuator in a desired position.

In an embodiment of the present combine concave, the rear surface of the disruptor bars is planar, and preferably, the disruptor bars each have a notched front surface opposite the rear surface. In an embodiment, the notch defines a right angle. In a preferred embodiment, the front surface of the disruptor bar has a hardface landing.

In another embodiment, a combine concave is provided, including a frame including a plurality of spaced, vertical frame members each having an upper end and an opposite lower end, a mount plate connecting the upper ends, and a mount clevis connecting the lower ends, a plurality of disruptor bars mounted to the frame in spaced, parallel orientation, a grating plate slidably positioned against a rear surface of each of the disruptor bars, the grating plate defining a plurality of spaced, parallel slots, the grating plate being movable relative to the disruptor bars between a first position, where s plate blocks spaces between said disruptor bars, and a second position, where said plate allows free passage of material through said disruptor bars. The vertical members have a plurality of vertically spaced grate retainers constructed and arranged to slidably retain the grating plate against the disruptor bars, and the concave has a grate positioner bracket slidably mountable on the frame and having at least one tooth for engaging a complementary opening on the grating plate, so that the grate positioner is movable with the grating plate relative to the frame, and is selectively fixable relative to the frame.

In an embodiment, the grate positioner bracket is configured as a grating positioner system, and includes a lever with a handle and a cam bushing configured for engaging a cam recess in an actuator, the actuator having said teeth for engaging the grating plate, so that rotation of the lever relative to the frame causes the actuator to move the grating plate between the first position and the second position relative to the concave, and the grate positioner bracket includes a user-releasable locking mechanism for securing the actuator in a desired position, the locking mechanism including a toothed rack biased into a locking position engaging teeth in the actuator

In yet another embodiment, a combine concave is provided, including, a frame including a plurality of spaced, vertical frame members each having an upper end and an opposite lower end, a mount plate connecting the upper ends, and a mount clevis connecting the lower ends, a plurality of disruptor bars mounted to the frame in spaced, parallel, a rear surface of the disruptor bars is planar, the disruptor bars each have a notched front surface opposite the rear surface, a grating plate slidably positioned against the rear surface of each of the disruptor bars, the grating plate defining a plurality of spaced, parallel slots, the grating plate being movable relative to the disruptor bars between a first position, where the plate blocks spaces between the disruptor bars, and a second position, where the plate allows free passage of material through the disruptor bars, and a grating positioner system includes a lever with a handle and a cam bushing configured for engaging a cam recess in an actuator, said actuator having teeth engaging complementary openings in said grating plate, so that rotation of said lever relative to said frame causes said actuator to move said grating plate between said first position and said second position relative to said concave, and said grating positioner system includes a user-releasable locking mechanism for securing said actuator in a desired position, said locking mechanism including a toothed rack biased into a locking position engaging teeth in said actuator.

### BRIEF DESCRIPTION OF THE DRAWINGS

FIG. 1 is side elevation of a prior art combine;

FIG. 2 is an inverted rear perspective view of the present combine concave;

FIG. 3 is a fragmentary enlargement of the combine concave of FIG. 2;

FIG. 4 is a rear exploded perspective view of the present combine concave;

FIG. 5 is side elevation of the present combine concave;

FIG. 6 is a front view of the present combine concave;

FIG. 7 is a side elevation of the present combine concave;

FIG. 8 is a rear view of the combine concave of FIG. 7;

FIG. 9 is an enlarged rear view of the combine concave of FIG. 8;

FIG. 10 is another side view of the present combine concave;

FIG. 11 is a fragmentary enlarged side view of the combine concave of FIG. 10;

FIG. 12 is another fragmentary enlarged side view of the combine concave of FIG. 10;

FIG. 13 is a front view of the present grating plate;

FIG. 14 is a side view of the grating plate of FIG. 13;

FIG. 15 is a side perspective view of the grating plate of FIG. 13;

FIG. 16 is a bottom perspective view of the present combine concave featuring an alternate grating adjustment mechanism;

FIG. 17 is an exploded perspective view of the grating adjustment mechanism of FIG. 16;

FIG. 18 is a fragmentary side view of the present combine concave showing the grating adjustment mechanism of FIG. 16;

FIG. 19 is a cross-section taken along the line 19-19 of FIG. 18 and in the direction generally indicated;

FIG. 20 is a bottom perspective view of the present grating adjustment mechanism in an initial adjustment position;

FIG. 21 is a bottom perspective view of the present grating adjustment mechanism in a second adjustment position; and

FIG. 22 is a bottom perspective view of the present grating adjustment mechanism in a third adjustment position.

### DETAILED DESCRIPTION

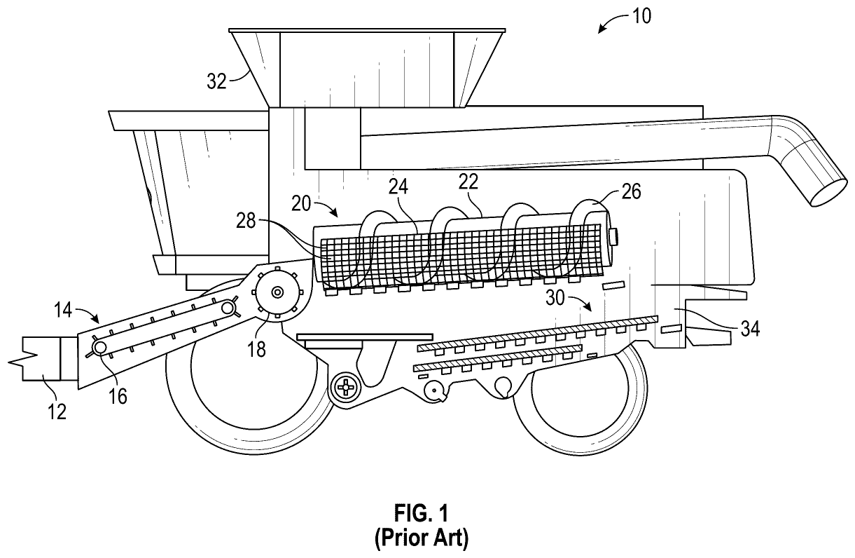

Referring now to FIG. 1, a typical combine 10 includes a header 12, which pushes into the crop in the direction of forward travel and cuts the crops. Once cut, the header 12 pushes the crops into a feeder housing 14. The feeder housing 14 encloses a conveyor belt 16 or other similar mechanism to pull the cut crops up into the combine 10 for threshing. Crops are delivered by the conveyor belt 16 to a feed accelerator 18, which is a rotating drum that pulls the crops into the machine, delivering it into a threshing assembly 20.

The threshing assembly 20 includes a rotor 22 and one or more concaves 24. Mainly a spinning cylinder, the rotor 22 is provided with projections 26 (also known as threshing elements). Conventionally, the concaves 24 are metal gratings with holes which are shaped to complementarily match the curve of the rotor 22. As the rotor 22 spins, the crops are rubbed against each other and dragged across the concaves 24, causing the crops to be threshed, i.e., the crop seeds (e.g., corn kernels) are released from the rest of the crop material. As the crops are threshed in the threshing assembly 20, the crop seeds fall through holes 28 of the concaves 24 through centrifugal force. The holes 28 of the concaves 24 are sized so that the crop seeds may fall through, but larger crop residue and material are retained inside the threshing assembly 20. Crop seeds passed through the concaves 24 are dropped into a cleaning shoe 30, where, using a succession of sieves or screens, the crop seeds are separated from the chaff before being collected in a grain tank 32. Crop residue is ejected from a combine outlet 34 to be deposited on the field.

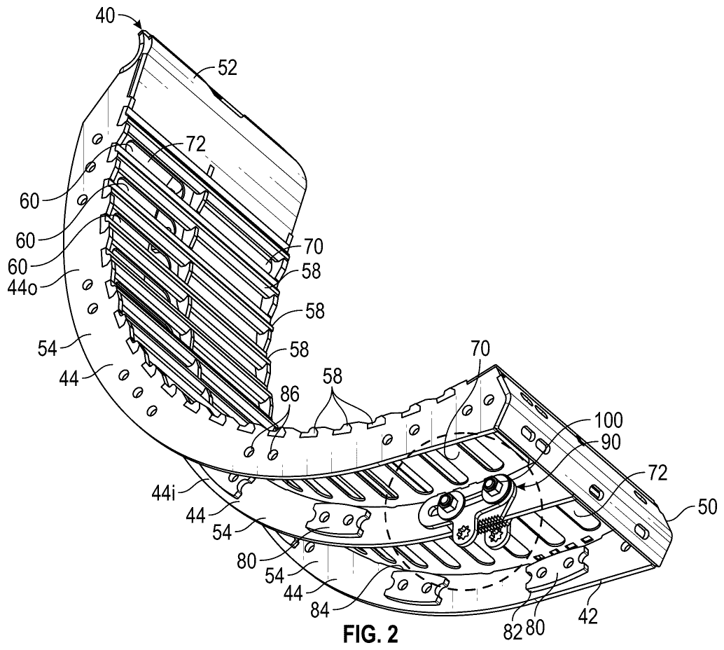

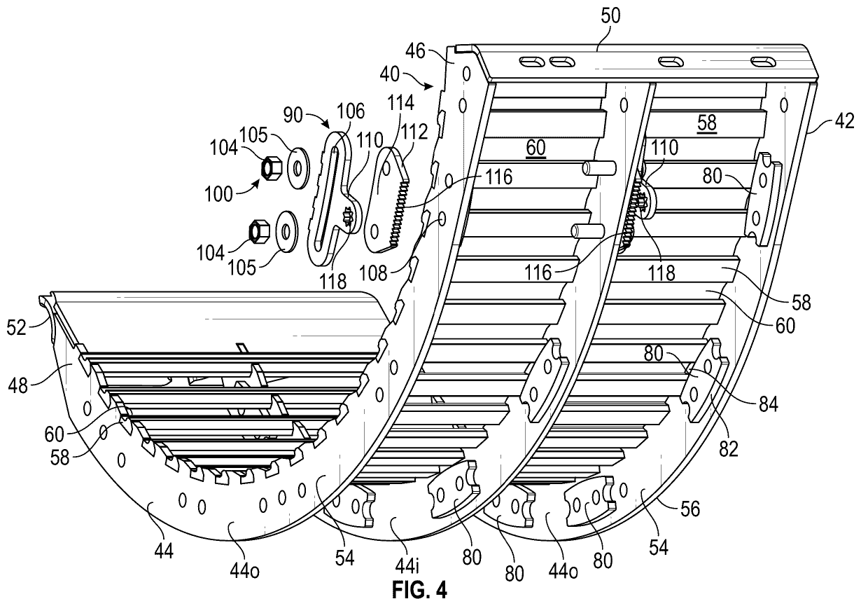

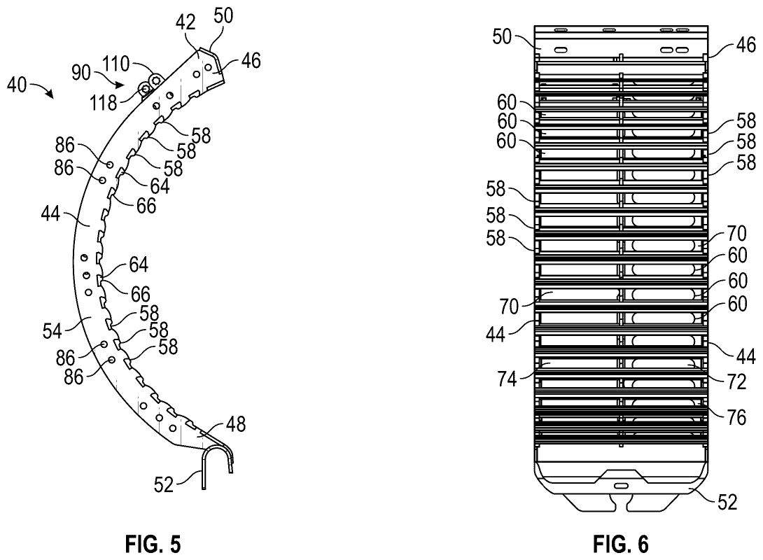

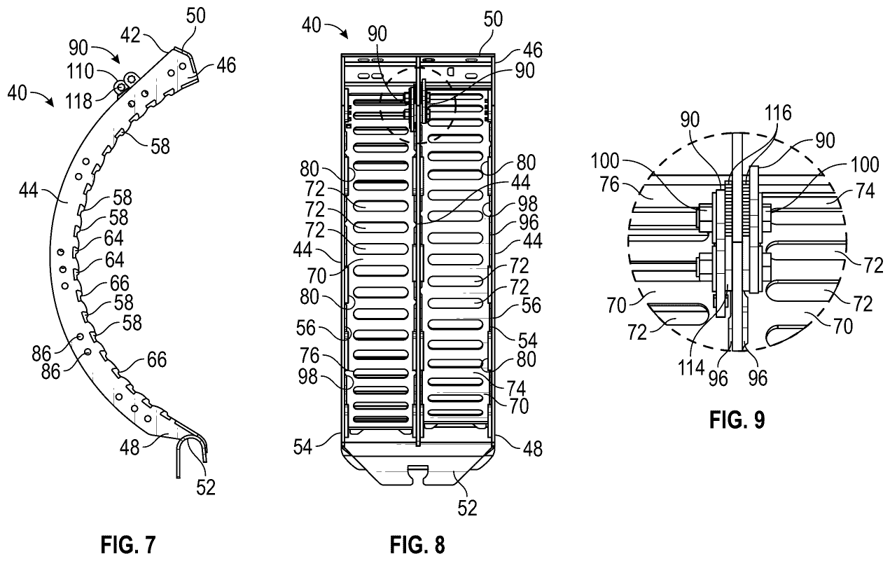

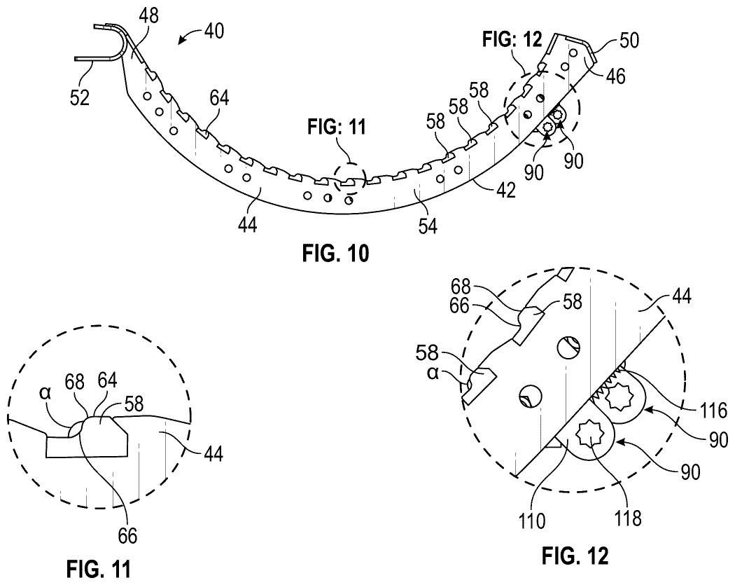

Referring now to FIGS. 2, 4, 5, 6, 7, 8, replacing the conventional concave 24, the present combine concave, generally designated 40, includes a frame 42 having a plurality of laterally-spaced, vertically projecting frame members 44, each such frame member having an upper end 46 and an opposite lower end 48, a mount plate 50 connecting the upper ends, and a mount clevis 52 connecting the lower ends, such connection being by welding, fasteners or the like. While it is contemplated that the number of frame members 44 may vary to suit the application, it is preferred that in the present concave 40 there are three such frame members, two outer members 44o and one mid-frame member 44i (FIG. 4). Also, each frame member 44 is preferably arcuately-shaped to be complementary to an outer circumference of the rotor 22, and has a first side 54 and a second side 56 (best seen in FIG. 8). Also, the configuration of the mount plate 50 and the mount clevis 54 are the same as in conventional concaves 24, so that the present concave 40 is easily mounted into, and removed from, standard combines 10 as a replacement part.

Referring now to 2, 4, 5 and 10-12, the present combine concave 40 also features a plurality of disruptor bars 58 mounted to the frame 42 in spaced, parallel orientation. Once assembled, the frame 42 of the concave 40 defines a plurality of spaces 60 between adjacent disruptor bars 58 through which crop seeds and residue pass during the threshing action.

In the present disruptor bars 58, a rear surface 62 is generally planar, and an opposite front surface 64 is initially semi-circular, but is machined down to have a notch 66. Preferably, the notch 66 defines a right angle α (best seen in FIG. 11). The notch 66 has been found to enhance the comminution action of the threshing assembly 20 by retaining plant material such as stalks, etc. against the concave 40 while the desired crop seeds are separated out to fall through the spaces 60. Another feature of the present disruptor bars 58 is a hardfaced landing 68 on the front surface 64, preferably in close proximity to the notch 66. The hardfaced landing 68 is made of an abrasion-resistant material, such as hardened steel, ceramic composite or the like, to accommodate the abrasive forces of the threshing operation without degrading the disruptor bars 58. It is also contemplated that once the hardfaced landing 68 becomes worn down, the concave 40 is removed, and a new bead or coating of hardfacing is applied.

Referring now to FIGS. 2, 3, 6, 8 and 9, also included on the present combine concave 40 is a grating plate 70 slidably positioned against the rear surface 62 of each of the disruptor bars 58, the grating plate defining a plurality of spaced, parallel slots 72. An important feature of the present combine concave 40 is that the grating plate 70 remains with the concave 40 regardless of the nature of the crop being harvested. This feature is achieved by the grating plate 70 being movable relative to the disruptor bars 58 between a first position 74 (left side, FIG. 6) where the plate blocks the spaces 60 between the disruptor bars 58, and a second position 76 (right side, FIG. 6), where the plate allows free passage of material through the spaces 60 on the disruptor bars. It will be seen that the concave 40 is contemplated has having multiple grating plates 70, each plate being slidably disposed between adjacent vertical frame members 44, including one such plate between members 44o and 44i, and another between members 44i and 44o.

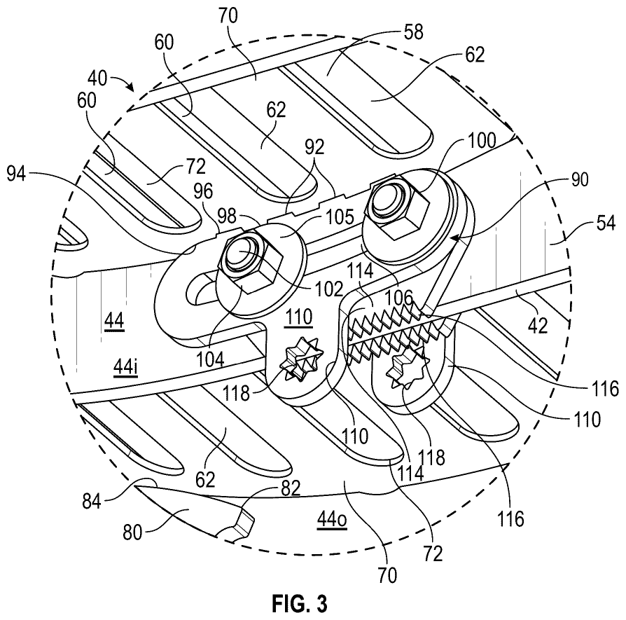

Referring now to FIGS. 2-4, another feature of the present combine concave 40 is that the vertical frame members 44 have a plurality of vertically-spaced grate retainers 80 constructed and arranged to slidably retain the grating plate 70 against the rear surface 62 of the disruptor bars 58. Preferably, the grate retainers 80 are located on at least one and preferably both of the sides 54, 56 (especially on the member 44i) of the frame members 44 and are affixed, as by welding, fasteners, chemical adhesives or the like. It is also preferred that each grate retainer 80 has an arcuate edge surface 82 configured for engaging the grating plate 70, preferably at an apex 84 of the surface 82 (FIGS. 2 and 3). Mounting openings 86 are provided in the grate retainer 80 to facilitate attachment to the frame 42.

Referring now to FIGS. 2, 3, 8 and 9, another feature of the present combine concave 40 is a mechanism for user-actuated sliding adjustment of the grating plate relative to the disruptor bars 58 and the frame 42. Preferably, this mechanism takes the form of a grate positioner bracket 90 slidably mountable on the frame 42 along axes of the frame members 44 and being configured for moving the grating plate 70 relative to the frame 42 between the first position 74 and the second position 76. In a preferred embodiment, the grate positioner bracket 90 has at least one tooth 92 (FIG. 3) projecting from an edge 94 for engaging a complementary opening 96 on an edge 98 of the grating plate 70, so that the grate positioner bracket is movable with the grating plate relative to the frame 42.

Referring now to FIGS. 3 and 4, once the desired position of the grating plate 70 is achieved relative to the frame 42, the grate positioner bracket 90 is selectively fixable relative to the frame. Preferably, the grate positioner bracket 90 is fixed to the frame 42 using fasteners 100, preferably a bolt 102 a nut 104 and a washer 105. These fasteners 100 engage the grate positioner bracket 90 in a slot 106 allowing the bracket, and the grating plate 70 to shift vertically relative to the frame 42. Corresponding fastener mounting holes 108 in the frame member 42 accommodate the fasteners 100.

To assist the user in achieving repeat positioning of the grating plate 70 each time the same crop is harvested, another aspect of the grate positioner bracket 90 is a rearward projecting portion 110 operationally engaging an indicator 112. The rearward projecting portion gives the grate positioner bracket 90 an overall “T”-shape. In the preferred embodiment, the indicator 112 is a plate 114 fixed to the frame member 44 in the vicinity of the grate positioner bracket 90, and having a plurality of points defining a sawtooth 116. The user can then associate the slidable rearward projecting portion 108 with a particular point of the sawtooth 114 to achieve a repeatable position of the grate positioner bracket 90 and the associated grating plate 70 relative to the frame 42.

Another feature of the grate positioner bracket 90 is a tool access aperture 118 on the rearward projecting portion 108. The aperture 116 is configured for accommodating a ratchet or a particular socket so that the user can use a tool to adjust the position of the grating plate 70 in the event it becomes stuck due to light rust, plant dust or debris or similar operational factor.

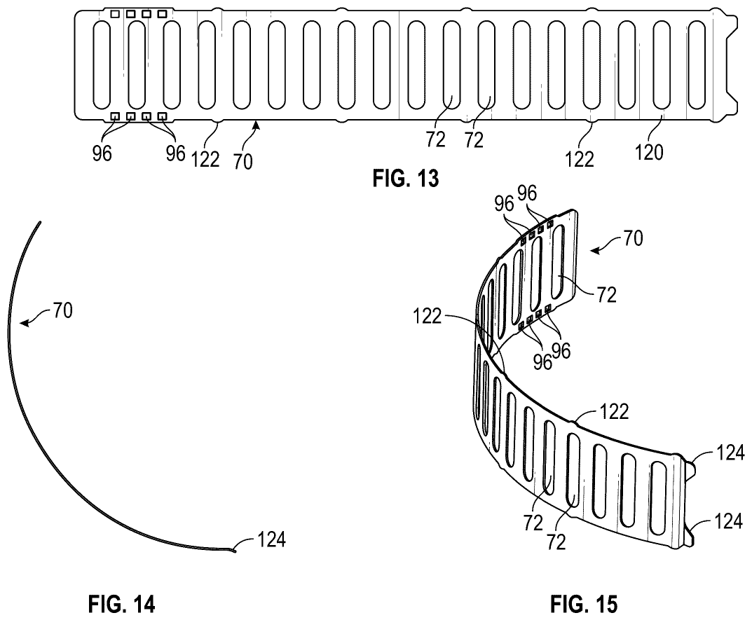

Referring now to FIGS. 13-15, the grating plate 70 is shown in greater detail. A peripheral edge 120 of the grating plate 70 is provided with a plurality of outwardly projecting edge protrusions 122 and at least two end protrusions 124. These protrusions engage the combine concave frame 42 to maintain the grating plate 70 in a centered position, and also peripherally space the grating plate from the frame to prevent the plate from becoming stuck to the frame by the presence of accumulated crop debris. While the present protrusions 122, 124 are generally hemispherical, they may vary as to shape, depending on the application.

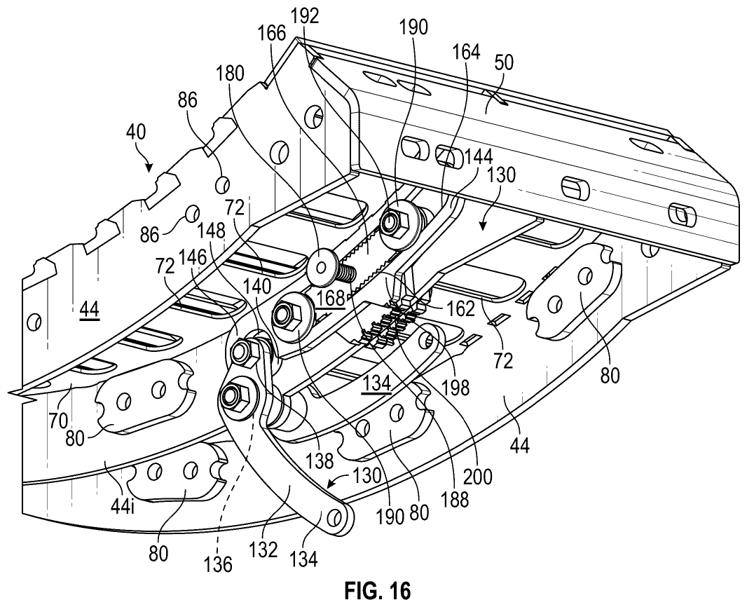

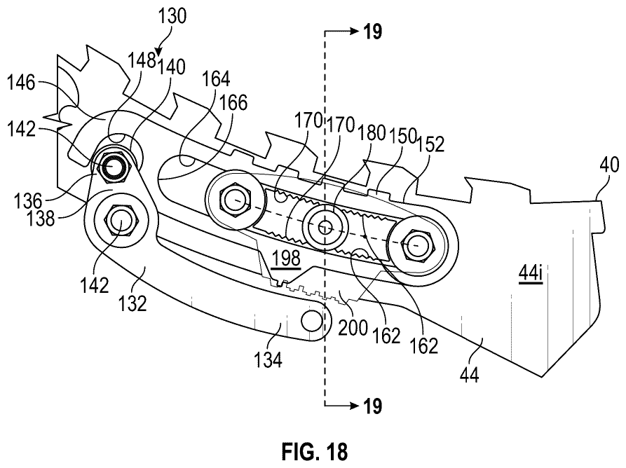

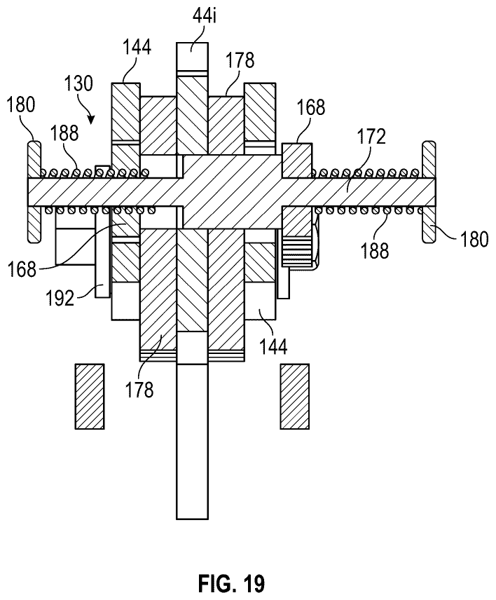

Referring now to FIGS. 16-22, an alternate embodiment to the grate positioner bracket 90 is generally designated as a grating adjustment mechanism 130, but functions generically similar to the grate positioner bracket in the movement of the grating plate 70 relative to the concave 40. Thus, the mechanism 130 and the bracket 90 can be functionally referred to collectively relating to the similarity in moving the grating plate relative to the concave. Advantages of the grating adjustment mechanism 130 over the grate positioner bracket 90 include increased user leverage over the grating plate 70 as it is moved between the first position 74 and the second position 76, and a more positive, yet user-friendly adjustment locking position. The grating adjustment mechanism 130 is considered more convenient for applications where the grating plate 70 becomes covered in crop debris, which might impair the adjustment operation. As such, greater user leverage is an important benefit. Also, the grating adjustment mechanism 130 features enhanced locking action to hold the grating plate in its designated operational position during combine operation.

Using the adjustment system 130, no tools are needed to adjust the grating plate 70 in the concave 40. A lever 132 is provided with a long handle 134 extending from a pivot opening 136. A generally triangularly-shaped cam 138 located on an opposite side of the pivot opening 136 from the handle 134 has a generally disc-shaped cam bushing 140 secured to the cam 138 using a cam fastener 142 (preferably a bolt and nut or equivalent).

An actuator 144 is analogous to the grate positioner bracket 90 but is distinctive in shape, is generally elongate in shape, with a cam end 146 having a cam recess 148 dimensioned to accommodate the cam bushing 140. Thus, user movement of the lever handle 134 will cause the cam bushing 140 to engage the cam recess 148 and thus slide the actuator 144 relative to the frame member 44, here preferably member 44i, however other above-described frame members are contemplated.

As is the case with the grate positioner bracket 90, the actuator 144 has teeth 150 on an upper actuator edge 152 that engage respective openings 96 on the grating plate 70. Thus, in view of this engagement, movement of the lever handle 134 will induce sliding movement of the grating plate 70 between the first, blocking position 74 and the second, open position 76. With this arrangement, the force required to slide the grating plate 70 is applied tangential to the direction of travel of the grating plate, rather than perpendicular, as is the case with the bracket 90. The use of the lever 132 and the cam bushing 140 gives an enhanced mechanical advantage to slide the grating plate 70.

Another feature of the alternate grating positioner system 130 is a more user-friendly yet positive apparatus for locking the actuator 144. Such a locking assembly or locking mechanism, generally designated 160, is needed to prevent the grating plate 70 from moving during combine operation. In the locking assembly 160, a plurality of gear teeth 162 are provided in at least one opposing edge 164 defining a preferably centrally-located slot 166 in the actuator 144. The gear teeth 162 inside the slot 166 engage with an internal gear rack 168, dimensioned to be accommodated within the slot 166 and having at least one and preferably opposing toothed edges 170 that matingly mesh with the slot gear teeth 162. Once the internal gear rack 168 is secured in place on the frame member 44i and is engaged with the gear teeth in the slot 166, the actuator 144 is prevented from moving relative to the concave 40, thus holding the grating plate 70 in the desired position.

However, depending on the particular crop being harvested, the user needs to be able to periodically adjust the position of the grating plate 70 relative to the concave 40, and as such, this locking relationship should preferably be releasable. To this end, a shaft 172 extends through an opening 174 in the concave frame member 44i and also through spacer openings 176 in each of a pair of spacers 178. The pair of spacers 178 is preferred so that there are two alternate grating positioner systems 130 on either side of the frame member 44i for moving adjacent grating plates 70.

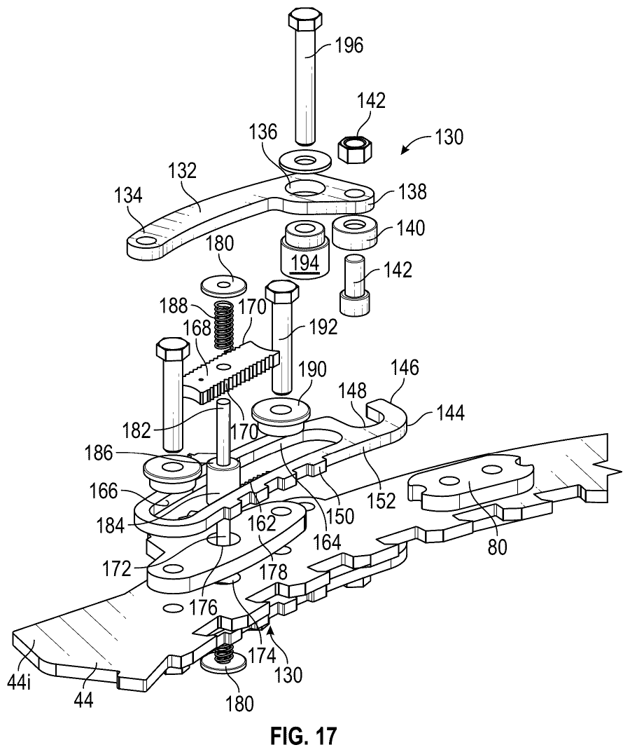

A knob 180 is secured to each end 182 of the shaft 172 to be used to push or pull the shaft relative to the frame member 44i. Also included on the shaft 172 is a larger diameter section 184 preferably in the center, which defines a seat 186 (FIG. 17) for the rack 168 that holds the rack in position within the actuator slot 166. A spring 188, preferably a coiled spring, is mounted on the shaft 172 between the handle and the rack to urge the rack against the seat 186. Since there are springs 188 on both ends of the shaft 172, they act together against the respective racks 168 inside the actuator slots 166 with teeth 162, 170 engaged. As will be described below, pulling on the knob 180 away from the frame member 44i will pull the seat 186 towards the user, and will cause the rack 168 to disengage from the actuator 144, thus unlocking and allowing sliding of the actuator and adjustment of the grating plate 70 under the force of the lever handle 134.

Referring now to FIGS. 17-19, the actuator 144 is held in place in sliding engagement with the frame member 44i using at least one and preferably two flanged actuator retainer bushings 190 slidably positioned in the slot 166 and secured to the frame member 44i by bolts 192 which also hold the spacer 178 to the frame member 44i

A handle mount bushing 194 rotatably receives the lever 132 and spaces it appropriately from the frame member 44i so that the cam bushing 140 engages the cam recess 148. A lever bolt 196 rotatably secures the lever and the handle mount bushing 194 to the frame member 44i.

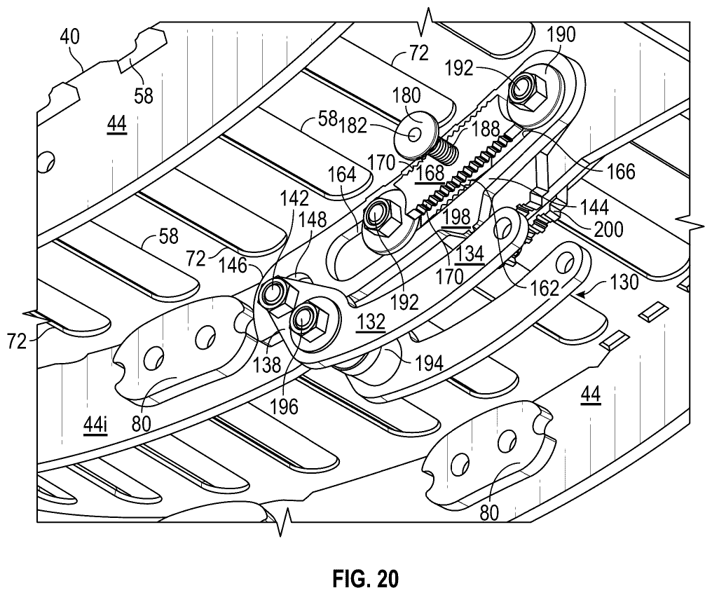

Referring now to FIG. 20, the lever 132 is shown positioned close to the frame member 44i and the actuator 144 is shown in a position so that the teeth 150 have moved the grating plate 70 to the fully closed position 74. The actuator slot 166 is also shown with one of the actuator retainer bushings 190 at one end of the slot so that further actuator movement to the left is prevented. Also, in this view, the actuator 144 preferably has an indicator wedge 198 that is in operational relationship to indicia 200 on the spacer 178 so that the user can note and compare the position of the grating plate 70 with adjacent plates on the concave 40 to obtain a more precise positioning of the plate. Also, the user can note the indicia position to repeat the adjustment each season for a particular crop. In FIG. 20, the indicator wedge 198 is shown positioned at a far edge of the indicia 200.

In FIG. 20, the user has decided to adjust the position of the grating plate 70 from the first, closed position 74. Accordingly, the rack 168 is pulled to release the actuator 144 by the user pulling on the knob 180, which overcomes the biasing force of the spring 188. The rack toothed edges 170 are now disengaged from the gear teeth 162.

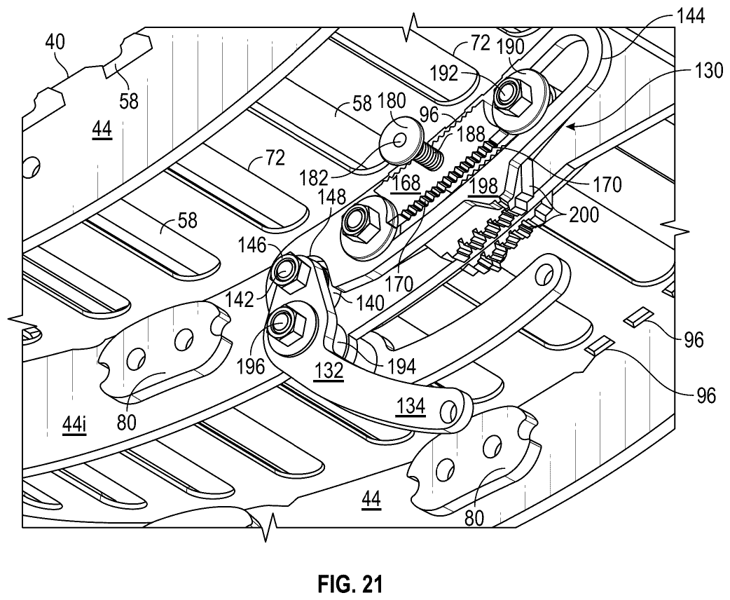

Referring now to FIG. 21, the user moves the handle 134 slowly clockwise, and the cam bushing 140 pushes the now-released actuator to the right, which also moves the grating plate 70 to the right and slightly opens the slots 72. Also, it is seen that the actuator 144 has moved relative to the flanged actuator retainer bushings 190 and the indicator wedge 198 has moved to the right relative to the indicia 200. If the user desires this position of the grating plate 70, he needs only to release the knob 180 and the spring 188 will push the rack 168 back into engagement with the actuator teeth 162.

Referring again to FIG. 16, the next sequentially opened grating plate position is shown, with the handle 134 in a slightly more advanced clockwise position, the actuator 144 slightly more to the right relative to the flanged actuator retainer bushings 190 and the indicator wedge 198 closer to the right relative to the indicia. In this view, the rack 168 is shown in the locked position.

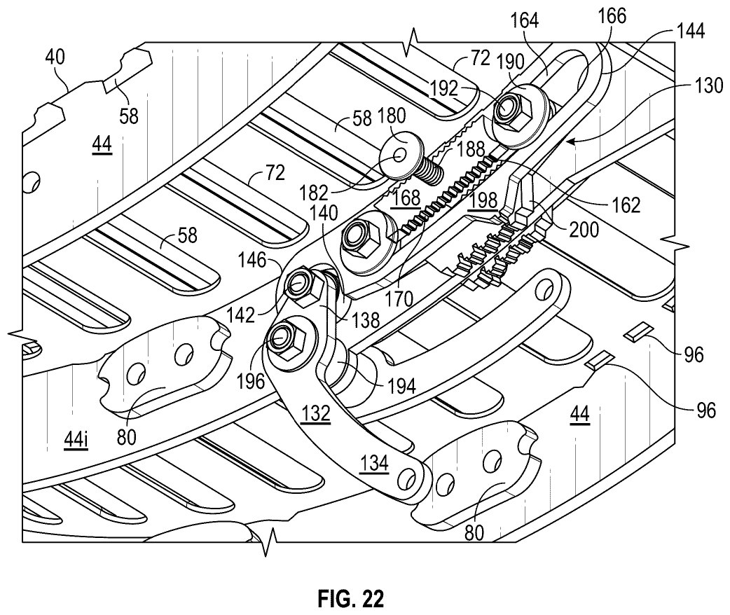

Referring now to FIG. 22, the handle 134 is rotated to the full clockwise position, and the cam bushing 140 has moved the actuator 144 to the right so that the grating plate 70 is in the fully open position 76. The actuator 144 is engaging the left most actuator retaining bushing 190 on the left end of the slot 66. Also, the indicator wedge 198 is fully right relative to the indicia 200. In this view, the rack 168 is shown in the pulled or unlocked position.

While a particular embodiment of the present combine concave with adjustable grating plate has been described herein, it will be appreciated by those skilled in the art that changes and modifications may be made thereto without departing from the invention in its broader aspects and as set forth in the following claims.

1. A combine concave, comprising:
a frame including a plurality of spaced, vertical frame members each having an upper end and an opposite lower end, a mount plate connecting said upper ends, and a mount clevis connecting said lower ends;
a plurality of disruptor bars mounted to said frame in spaced, parallel orientation;
a grating plate slidably positioned against a rear surface of each of said disruptor bars, said grating plate defining a plurality of spaced, parallel slots;
said grating plate being movable relative to said disruptor bars between a first position, where said plate blocks spaces between said disruptor bars, and a second position, where said plate allows free passage of material through said disruptor bars.

2. The combine concave of claim 1, wherein said vertical members have a plurality of vertically spaced grate retainers constructed and arranged to slidably retain said grating plate against said disruptor bars.

3. The combine concave of claim 2, wherein each said grate retainer has an arcuate surface configured for engaging said grating plate.

4. The combine concave of claim 1, further including a grate positioner bracket slidably mountable on said frame and being configured so that said grate positioner bracket is movable with said grating plate relative to said frame.

5. The combine concave of claim 4, wherein said grate positioner bracket is selectively fixable relative to said frame using threaded fasteners.

6. The combine concave of claim 4, wherein said grate positioner bracket includes a rearward projecting portion operationally engaging an indicator.

7. The combine concave of claim 6, wherein said indicator has a sawtoothed edge.

8. The combine concave of claim 4, wherein said grate positioner bracket has at least one tooth for engaging a complementary opening on said grating plate.

9. The combine concave of claim 6, wherein said projecting portion has a tool access aperture.

10. The combine concave of claim 4, wherein said grate positioner bracket is configured as a grating positioner system, and includes a lever with a handle and a cam bushing configured for engaging a cam recess in an actuator, said actuator having teeth engaging said grating plate, so that rotation of said lever causes said actuator to move said grating plate between said first position and said second position relative to said concave.

11. The combine concave of claim 10, further included a user-releasable locking mechanism for securing said actuator in a desired position.

12. The combine concave of claim 1, wherein said rear surface of said disruptor bars is planar.

13. The combine concave of claim 12, wherein said disruptor bars each have a notched front surface opposite said rear surface.

14. The combine concave of claim 13, wherein said notch defines a right angle.

15. The combine concave of claim 13 wherein said front surface of said disruptor bar has a hardfaced landing.

16. A combine concave, comprising:
a frame including a plurality of spaced, vertical frame members each having an upper end and an opposite lower end, a mount plate connecting said upper ends, and a mount clevis connecting said lower ends;
a plurality of disruptor bars mounted to said frame in spaced, parallel orientation;
a grating plate slidably positioned against a rear surface of each of said disruptor bars, said grating plate defining a plurality of spaced, parallel slots;
said grating plate being movable relative to said disruptor bars between a first position, where said plate blocks spaces between said disruptor bars, and a second position, where said plate allows free passage of material through said disruptor bars;
said vertical members have a plurality of vertically spaced grate retainers constructed and arranged to slidably retain said grating plate against said disruptor bars; and
a grate positioner bracket slidably mountable on said frame and having at least one tooth for engaging a complementary opening on said grating plate, so that said grate positioner is movable with said grating plate relative to said frame, and is selectively fixable relative to said frame.

17. The combine concave of claim 14, wherein said grate bracket has a peripheral edge having a plurality of outwardly projecting protrusions.

18. The combine concave of claim 14, wherein said grate positioner bracket is configured as a grating positioner system, and includes a lever with a handle and a cam bushing configured for engaging a cam recess in an actuator, said actuator having said teeth for engaging said grating plate, so that rotation of said lever relative to said frame causes said actuator to move said grating plate between said first position and said second position relative to said concave, and said grate positioner bracket includes a user-releasable locking mechanism for securing said actuator in a desired position, said locking mechanism including a toothed rack biased into a locking position engaging teeth in said actuator.

19. A combine concave, comprising:
a frame including a plurality of spaced, vertical frame members each having an upper end and an opposite lower end, a mount plate connecting said upper ends, and a mount clevis connecting said lower ends;
a plurality of disruptor bars mounted to said frame in spaced, parallel, a rear surface of said disruptor bars is planar, said disruptor bars each have a notched front surface opposite said rear surface;
a grating plate slidably positioned against said rear surface of each of said disruptor bars, said grating plate defining a plurality of spaced, parallel slots;
said grating plate being movable relative to said disruptor bars between a first position, where said plate blocks spaces between said disruptor bars, and a second position, where said plate allows free passage of material through said disruptor bars; and
a grating positioner system includes a lever with a handle and a cam bushing configured for engaging a cam recess in an actuator, said actuator having teeth engaging complementary openings in said grating plate, so that rotation of said lever relative to said frame causes said actuator to move said grating plate between said first position and said second position relative to said concave, and said grating positioner system includes a user-releasable locking mechanism for securing said actuator in a desired position, said locking mechanism including a toothed rack biased into a locking position engaging teeth in said actuator.

20. The combine concave of claim 19, wherein said vertical members have a plurality of vertically spaced grate retainers constructed and arranged to slidably retain said grating plate against said disruptor bars.
